(19) United States
(12) Patent Application Publication
(10) Pub. No.: US 2016/0288728 A1
(43) Pub. Date: Oct. 6, 2016

(54) Hitch-Mounted Door Carrier

(71) Applicant: Todd Sampson, Martinsburg, WV (US)

(72) Inventor: Todd Sampson, Martinsburg, WV (US)

(21) Appl. No.: 15/090,312

(22) Filed: Apr. 4, 2016

Related U.S. Application Data
(60) Provisional application No. 62/142,018, filed on Apr. 2, 2015.

(51) Int. Cl. B60R 9/06; B60D 1/62; B62D 63/08

(52) U.S. Cl. CPC B60R 9/06; B62D 63/08; B60D 1/62

(57) ABSTRACT

A hitch-mounted door carrier for supporting vehicle doors is provided. The carrier comprises a lower frame having a front and a rear, whereby the front includes a plurality of door pin sleeves and the rear preferably includes a plurality of door strike pins. The strike pins and pin sleeves form pairs of door supports. Each pair is aligned longitudinally, whereby a vehicle door can be supported therebetween. The sleeves are used to support the front of the vehicle door, while the door strike pins engage the rear door latch thereof. The sleeves are supported by upright members extending from the front of lower frame. The strike pins are supported along a rear frame, which extends upwards from the rear of the lower frame. The carrier device is supported by the hitch of a tow vehicle and may be suited to carrying one or more vehicle doors.

### CROSS REFERENCE TO RELATED APPLICATION

This application claims the benefit of U.S. Provisional Application No. 62/142,018 filed on Apr. 2, 2015. The above identified patent application is herein incorporated by reference in its entirety to provide continuity of disclosure.

### BACKGROUND OF THE INVENTION

### Field of the Invention

The present invention relates to trailers and cargo carrier devices. More specifically, the present invention relates to a carrier device that is supported by a trailer hitch, whereby the carrier is adapted to support removed vehicle doors thereon. The device is particularly suited for transporting replacement doors, or removable doors from certain vehicles (i.e., off-road vehicles and the like).

Some vehicles, such as off-road vehicles and certain sport utility vehicles, have removable doors. This allows owners to remove the doors as desired when off-road or during hot weather months. Many owners utilize this feature to remove the doors of the vehicle during warm weather in order to enhance the enjoyment of driving the vehicle. This can be problematic, however, if the weather turns inclement or other issues arise. The driver may be stuck without doors on his or her vehicle, allowing debris or water to enter the cabin of the vehicle.

Many owners of such vehicles would desire a way to transport the vehicle's removed doors along with them. However, the doors are quite difficult to transport and would take up considerable space in the vehicle. Therefore, there is a need in the prior art for a convenient, effective means for transporting the removable doors of a vehicle without taking up space within the vehicle itself.

The present invention relates to a hitch-attachable carrier for removed vehicle doors, whereby the doors are supported in the front by their door pins, and optionally in the rear by way of their door latches. In particular, the present invention provides a means to transport removed doors in-tow, whereby the doors are supported by a hitch-mounted carrier. Therefore, the doors are not carried within the vehicle, and thus interior cabin space is not compromised as a result. This allows users to transport removed doors to a desired destination, and have easy access thereto when the doors need to be reattached. Caster wheels along the lower surface of the carrier allow the carrier to be rolled along the ground when not being supported by a vehicle. Overall, the present invention is also useful for transporting vehicle doors, whereby the doors can be supported outside of the vehicle and transported from one location to another.

### SUMMARY OF THE INVENTION

The following summary is intended solely for the benefit of the reader and is not intended to be limiting in any way. The present invention provides a new hitch-mounted door carrier device that can be utilized for providing convenience for the user when transporting removed vehicle doors.

It is therefore an object of the present invention to provide a new and improved hitch-mounted door carrier device that has all of the advantages of the prior art and none of the disadvantages.

It is another object of the present invention to provide a hitch-mounted door carrier device that can be used to transport vehicle doors along the rear of a vehicle, whereby the carrier device is adapted to be supported by the hitch of a vehicle or via the caster wheels of the device. The device supports doors removed from the vehicle supporting the carrier, or vehicle doors generally, when transporting the doors from one location to another.

Another object of the present invention is to provide a hitch-mounted door carrier device that in one embodiment comprises a substantially rectangular lower frame having a pair of side frame members and a pair of cross frame members. The lower frame has a front and a rear, whereby the front includes door pin sleeves and the rear includes optional door strike pins.

Another object of the present invention is to provide a hitch-mounted door carrier embodiment with sets of door supports for each supported door, whereby each set comprises a corresponding pair of door pin sleeves and door strike pins.

Another object of the present invention is to provide a hitch-mounted door carrier device that further comprises a draw bar extending from the front of the lower frame. The draw bar is adapted to be received by the trailer hitch of a lead vehicle, which supports the draw bar and supports the carrier device along the rear of the vehicle.

Another object of the present invention is to provide a hitch-mounted door carrier device that comprises a first upright member and a second upright member extending upward from the lower frame. Additionally, the carrier device includes a third upright member and a fourth upright member extending upward from the lower frame. The third upright member and the fourth upright member are positioned laterally inboard of the first upright member and the second upright member, and each of the first, second, third, and fourth upright members support one or more door pins sleeves thereon.

Another object of the present invention is to provide a hitch-mounted door carrier device in which each door pin sleeve is adapted to support a door pin and the front of a vehicle door.

Another object of the present invention is to provide a hitch-mounted door carrier device that comprises a rear frame disposed along the rear of the lower frame, whereby the rear frame extends upward from the lower frame and optionally includes a plurality of door strike pins therealong. The rear frame may be statically disposed along the carrier or hingedly mounted thereto to pivot the rear frame between an upright and lowered position.

Another object of the present invention is to provide a hitch-mounted door carrier device in which the optional door strike pins of the rear frame are adapted to secure to the door latch of a vehicle door along the rear portion of the vehicle door.

Another object of the present invention is to provide a hitch-mounted door carrier device in which each door strike pin is longitudinally aligned with at least one door pin sleeve to form a set of door supports, whereby each set of door supports is adapted to support a single vehicle door therebetween.

Another object of the present invention is to provide a hitch-mounted door carrier device, whereby the third upright member and the fourth upright member are rearward of the first upright member and the second upright member such that the third upright member and the fourth upright member are closer to the rear frame than the first upright member and the second upright member.

Another object of the present invention is to provide a hitch-mounted door carrier device whereby the plurality of door strike pins on the rear frame further comprise a pair of outer door strike pins and a pair of inner door strike pins. The outer door strike pins align longitudinally with the door pin sleeves of the first upright member and the second upright member. The inner door strike pins aligning longitudinally with the door pin sleeves of the third upright member and the fourth upright member. In this manner, smaller vehicle doors are supported between the inner door strike pins and the third upright member and the fourth upright member, as compared to vehicle doors that can be supported between the outer door strike pins and the first upright member and the second upright member.

Another object of the present invention is to provide a hitch-mounted door carrier device whereby the lower frame further comprises a longitudinal member extending between the lower frame and the rear frame. The longitudinal member further comprises a lockable joint therealong such that the longitudinal member is rotatable about the lockable joint between a lowered position and a stowed position.

Another object of the present invention is to provide a hitch-mounted door carrier device, whereby the rear of the lower frame further comprises vehicle taillights and a corresponding electrical connector to receive electrical signals from a lead vehicle when the drawbar is attached to a vehicle trailer hitch.

Another object of the present invention is to provide a hitch-mounted door carrier device, wherein the first upright member is connected to the third upright member by at least one diagonal brace extending between the ends thereof. The second upright member is connected to the fourth upright member by at least one diagonal brace, which extend between the ends thereof. The diagonal braces are parallel to the lower frame.

Another object of the present invention is to provide a hitch-mounted door carrier device, whereby rear vehicle doors are supported between the rear frame and the third upright member and the fourth upright member. Front vehicle doors are supported between the rear frame and the first upright member and the second upright member.

Another object of the present invention is to provide a hitch-mounted door carrier device, whereby the first upright member and second upright member each further comprise a pair of vertically aligned door pin sleeves. The third upright member and fourth upright member also each further comprise a pair of vertically aligned door pin sleeves.

Another object of the present invention is to provide a hitch-mounted door carrier device in which the draw bar is disposed along the longitudinal centerline of the lower frame.

Another object of the present invention is to provide a hitch-mounted door carrier device, wherein an embodiment comprises a lower frame having a longitudinal member and a rear member substantially perpendicular thereto. A first upright frame and a second upright frame extend upward from the lower frame and extend longitudinally along the lower frame. A third upright frame and a fourth frame extend laterally between the first upright frame and the second upright frame. In this embodiment, at least one door pin sleeve is disposed outboard of the first upright frame and the second upright frame, while the rear frame of the carrier includes a plurality of door strike pins. Each of the door strike pins is longitudinally aligned with at least one of the door pin sleeves to form a set of door supports, whereby each set of door supports is adapted to support a single vehicle door.

Another object of the present invention is to provide a hitch-mounted door carrier device, further comprising a forward pair of door pin sleeves and a rear pair of door pin sleeves extending outward from each of the first upright frame and the second upright frame. The forward pair of door pin sleeves is vertically aligned and the rear pair of door pin sleeves is vertically aligned, whereby the forward pair of door pin sleeves is disposed closer to the front of the lower frame than the rear pair of door pin sleeves.

Another object of the present invention is to provide a hitch-mounted door carrier device whereby the plurality of door strike pins on the rear frame comprise a pair of outer door strike pins and a pair of inner door strike pins. The outer door strike pins align longitudinally with one of the forward pair of door pin sleeves of the first upright frame and the second upright frame. The inner door strike pins align longitudinally with one of the rear pair of door pin sleeves of the first upright frame and the second upright frame. In this manner, smaller vehicle doors are supported between the inner door strike pins and the rear door pin sleeves, as compared to vehicle doors supported between the outer door strike pins and the forward door pin sleeves.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a side view of an embodiment of the hitch-mounted carrier of the present invention.

FIG. 1B shows a side view of another embodiment of the hitch-mounted carrier of the present invention.

FIG. 2 shows an overhead view of an embodiment of the hitch-mounted carrier of the present invention.

FIG. 3 shows a perspective view of an embodiment of the hitch-mounted carrier of the present invention.

FIG. 4 shows a perspective view of yet another embodiment of the hitch-mounted carrier of the present invention.

FIG. 5 shows a perspective view of yet another embodiment of the hitch-mounted carrier of the present invention.

FIG. 6 shows a view of hitch-mounted carrier of the present invention in a stowed state.

### DETAILED DESCRIPTION OF THE INVENTION

Reference is made herein to the attached drawings. Like reference numerals are used throughout the drawings to depict like or similar elements of the hitch-mounted carrier device of the present invention. For the purposes of presenting a brief and clear description of the present invention, the preferred embodiment will be discussed as used for supporting vehicle doors using a carrier device. The figures are intended for representative purposes only and should not be considered to be limiting in any respect.

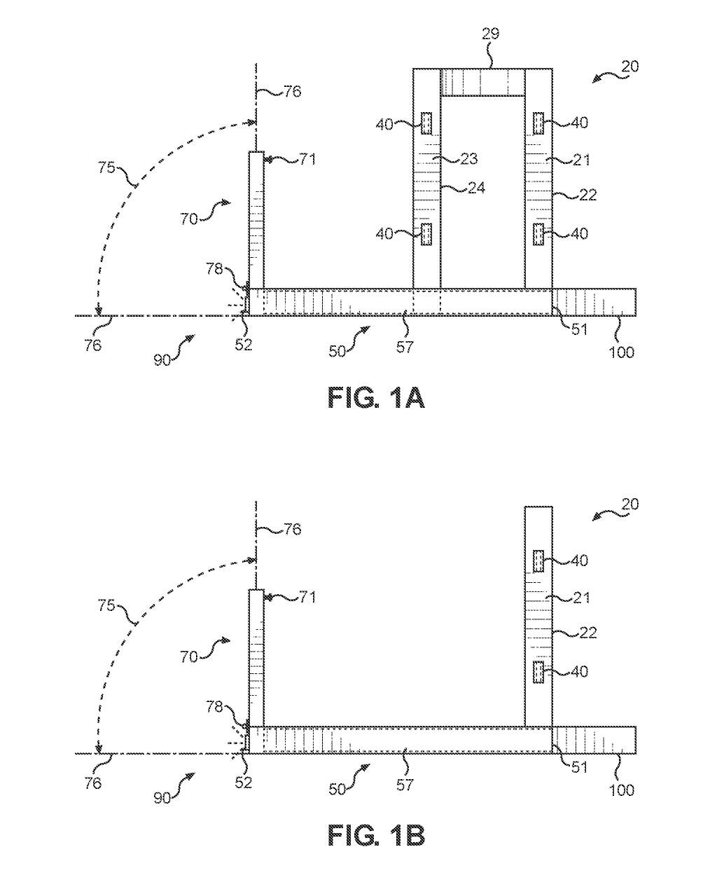

Referring now to FIG. 1A, there is shown a side view of an embodiment of the hitch-mounted carrier device of the present invention. The carrier is one that is adapted to support one or more vehicle doors thereon and one that can be supported by a trailer hitch of a lead vehicle. This allows a user to carry removed vehicle doors from the lead vehicle, or doors generally. When not being supported by a lead vehicle, caster wheels may be positioned along the lower surface thereof to allow the carrier to be rolled over a surface while supporting doors thereon. Each supported door is positioned longitudinally along the carrier, whereby doors of different size are accommodated. The front of each door is supported along the front of the carrier, while the rear of the door is supported along the rear of the carrier. Each end of the door is supported using specific connectors to ensure the door remains connected to the carrier during transport.

In the embodiment shown in FIG. 1A, the carrier comprises a lower frame 50, an upstanding forward frame assembly 20, and an upstanding rear frame 70. Vehicle doors of two different sizes are supported longitudinally along the carrier, whereby the front of the doors are supported by door pin sleeves 40 on the forward frame assembly 20, and the rear of the vehicle doors are supported by door strike pins 70 on the rear frame. Extending forward of the lower frame 50 along the front 51 thereof is a carrier draw bar 100. The draw bar 100 extends forward and preferably in-plane with the lower frame 50, and is used to secure the carrier to the trailer hitch of a lead vehicle. The draw bar 100 may comprises a rectangular structure that is received within the hitch receiver of a lead vehicle trailer hitch, whereby the carrier is cantilevered from the trailer hitch.

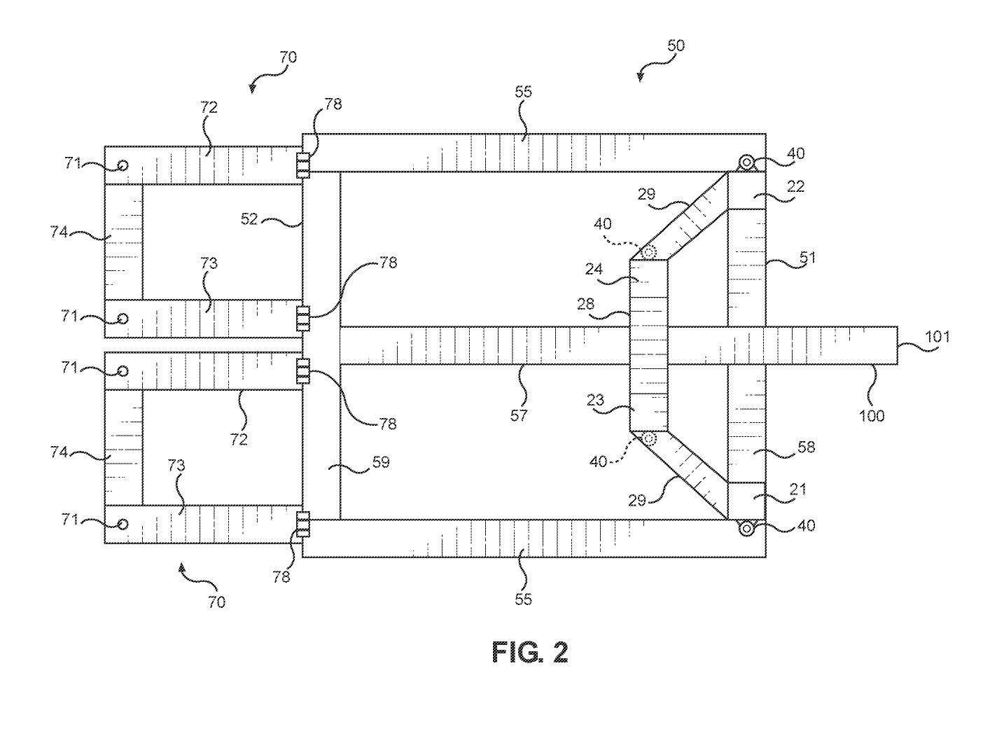

FIGS. 1A through 6 show different embodiments of the forward frame assembly 20. As shown in FIG. 1A and FIGS. 2-3, the forward frame assembly 20 comprises a first upright member 21 and a second upright member 22 extending upward from the lower frame 50. Rearward of the first and second upright members 21, 22 are a third upright member 23 and a fourth upright member 24 extending upward from the lower frame 50. The four upright members are substantially parallel to one another and substantially perpendicular to the lower frame, 50. The lower frame 50 may include a singular longitudinal member 57 between the forward frame assembly 20 and the rear frame 70, or the lower frame 50 may also include a pair of side frame members 55 extending therebetween. Along the ends of the lower frame 50 is a front cross member 58 and a rear cross member 59.

In the embodiment shown in FIG. 1A and FIGS. 2-3, the third upright member 23 and the fourth upright member 24 are both positioned laterally inboard of the first upright member 21 and the second upright member 22. This allows the different upright members of the carrier to be offset laterally from one another, thereby allowing each of the upright members to support an individual vehicle door between the forward frame assembly 20 and the rear frame 70. Preferably, the upright members of the forward frame assembly 20 are used to support the front of one or more vehicle doors. The rear of the supported doors may be unsupported, or may be supported by the rear frame 70.

In additional to being laterally offset, the upright members of the forward frame assembly 20 may be offset longitudinally along the length of the carrier. In particular, the third upright member 23 and the fourth upright member 24 may be positioned rearward along the carrier with respect to the first upright member 21 and the second upright member 22. In this manner, the third upright member 23 and the fourth upright member 24 are closer to the rear frame 70 than the first upright member 21 and the second upright member 22. This allows the first and second upright members to support longer doors than the third and fourth upright members, where the rear frame 70 supports the rear of each vehicle door in substantially the same longitudinal position. This generally allows the first 21 and second 22 upright members to support front vehicle doors, while the third 23 and fourth 24 upright members support rear vehicle doors. Rear vehicle doors generally have a smaller overall length, thus a different span between the upright members and the rear frame is necessary to carry both front and rear doors.

Also shown in the embodiment of FIGS. 1A and 2-3 is support structure within the forward frame assembly 20. The support structure may include brace members between the upright members to form a first and second upright frame 203 and a third 201 and fourth upright frame 202 extending laterally between the first and second upright frames 203. In one configuration of the upright frames, the first upright member 21 is connected to the third upright member 23 by a first set of diagonal braces 29. This may include both upper and lower braces, whereby the braces 29 are parallel to the lower frame. Similarly, the second upright member 22 is connected to the fourth upright member 24 are connected by a second set of diagonal braces, which may extend between both the upper ends and lower ends thereof, and whereby the second set of diagonal brace 29 is parallel to the lower frame. Finally, cross braces 25, 28 are provided to secure the third 23 and fourth 24 upright members to the lower frame 50. Specifically, an upper cross brace 25 may extend between the upper ends of the third 23 and fourth 24 upright members, and a lower cross brace 28 may extend between the lower ends of the third 23 and fourth 24 upright members.

Extending along the centerline and in a longitudinal direction along the lower frame 50 is a longitudinal member 57. The longitudinal member 57 extends between the front 51 and the rear 52 of the lower frame 50 and from the front cross member 58 to the rear cross member 59. The longitudinal member 57 may connect to the cross brace 28 supporting the third 23 and fourth 24 upright members. The longitudinal member 57 may also be aligned with the draw bar 100 and formed from one continuous length of material to form the draw bar 100 and aligned longitudinal member 57.

Still viewing the embodiment shown in FIG. 1A and FIGS. 2-3, at least one door pin sleeve 40 disposed on each of the first upright member 21, the second upright member 22, the third upright member 23, and the fourth upright member 24. Each door pin sleeve 40 is adapted to support the front of a vehicle door using a door pin and the clevis or sleeve of the vehicle door. The door pin sleeve 40 accepts the door pin of the vehicle door, and rotatably secures the vehicle door along the front thereof to the particular upright member. Certain doors, including common sport utility and off road vehicles, employ pin join door connections. The door pin sleeves 40 of the carrier replicate the door pin sleeves of the particular vehicle, and allow direct transfer of the door from the vehicle and to the carrier.

Along the rear 52 of the carrier is the rear frame 70. The rear frame 70 extends upward from the lower frame 50 and may include a plurality of door strike pins 71 therealong. The door strike pins 70 are adapted to secure to the door latch of a vehicle door, which is disposed along the rear of each vehicle door. The strike pins 70 engage the door latch in the same manner as the strike pins 70 of a vehicle, which operably allows the rear of the vehicle to door to secure to the frame of the vehicle or to release therefrom when opening and closing the door. Each of the door strike pins 70 is longitudinally aligned with at least one of the door pin sleeves 40 to form a set of door supports, whereby each set of door supports is adapted to support a single vehicle door.

In one embodiment, each of the upright members may include a pair of vertically aligned door pin sleeves 40, whereby each pair of sleeves aligns with a single door strike pin 71. In particular, the plurality of door strike pins 71 on the rear frame may comprises a pair of outer door strike pins and a pair of inner door strike pins. The outer door strike pins align longitudinally with the door pin sleeves 40 of the first upright member 21 and the second upright member 22. The inner door strike pins align longitudinally with the door pin sleeves 40 of the third upright member 23 and the fourth upright member 24. In this way, smaller vehicle doors are supported between the inner door strike pins and the third upright member 23 and the fourth upright member 24, as compared to vehicle doors supported between the outer door strike pins and the first upright member 21 and the second upright member 22.

The strike pins 71 are disposed along the height of the rear frame 70, which is disposed along the rear 52 of the lower frame 50. In some embodiments, the rear frame 50 is a static structure, extending upwards from the lower frame 50. In others, the rear frame 50 is pivotably attached to the lower frame 50 using one or more hinges 78. Similarly, the rear frame 50 may comprises a singular frame, or may comprise two or more independently pivotable structures. When pivoting, the rear frame 50 is rotatable 75 between an upright position 76 and a lowered position 76. A rotatable frame allows the user to provide clearance for the vehicle doors while mounting the same from the front along the upright members, thereafter the rear frame 70 can be rotated into position to engage the rear of the vehicle doors.

In another embodiment of the carrier device of the present invention and as shown in FIG. 1B, the forward frame assembly 20 may comprise a planar structure. In particular, the forward frame assembly may comprise a first upright member 21 and a second upright member 22 only, thereby allowing the carrier to support doors of a singular size between the forward frame assembly 20 and the rear frame 70. The upright members 21, 22 may have cross members therebetween for additional support. As in the first embodiment, the rear frame 70 extends upward from the lower frame 50 and may comprise a plurality of door strike pins 71 therealong. The door strike pins 71 are adapted to secure to a door latch of a vehicle door, whereby each of the door strike pins is longitudinally aligned with at least one of the door pin sleeves 40 to form a set of door supports. Each set of door supports is adapted to support a single vehicle door.

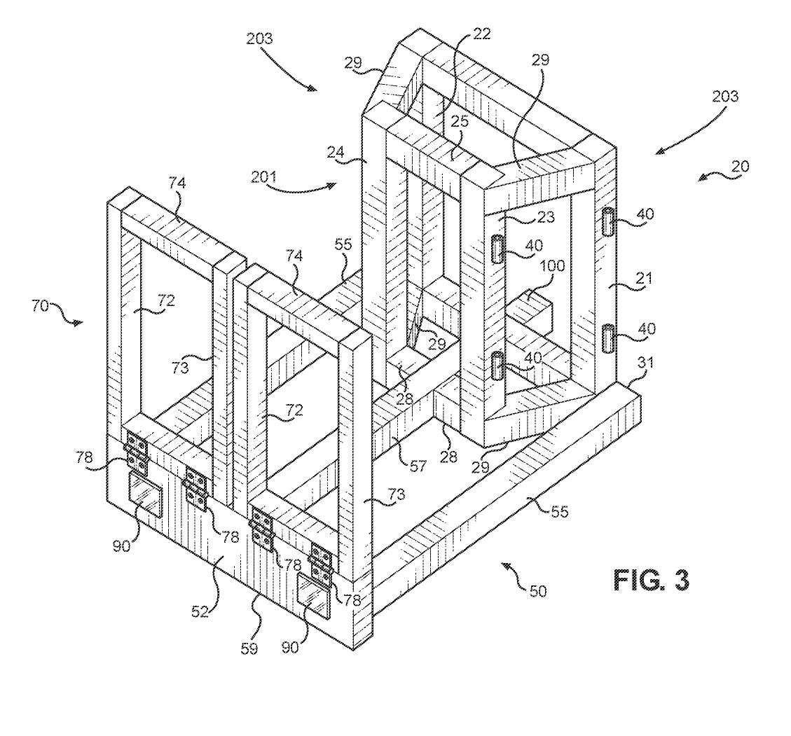

Since the carrier is designed to be supported along the rear of the vehicle, it is contemplated that the carrier include signals and brake lights along the rear thereof. In particular, the rear of the carrier may include vehicle taillights 90 (FIG. 3), including signals and brake indicators. The vehicle taillights 90 connect to the lead vehicle using one or more electrical connectors, which transmit electrical signals from a lead vehicle when the drawbar is attached to a vehicle trailer hitch and the connector is electrically coupled thereto.

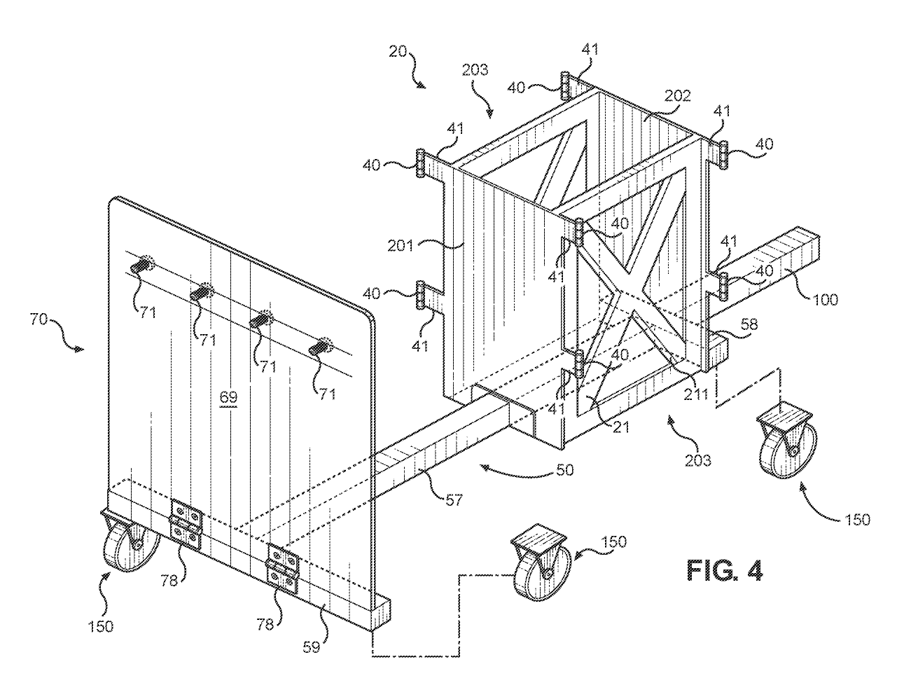

Referring finally to FIG. 4, there is shown yet another embodiment of the present invention. In this embodiment, the lower frame 50 comprises a singular longitudinal member 57 with a front cross member 58 and rear cross member 59 extending substantially perpendicular thereto along the front and rear thereof. The draw bar 100 extends from the front of the lower frame 50. The forward frame assembly 20 comprises a plurality of planar frames 201, 202, 203. More specifically, the forward frame assembly 20 comprises a first and second upright frame 203 extending upward from the lower frame 50 and extending longitudinally along the lower frame 50. A third frame 201 and a fourth frame 202 extend laterally between the first and second upright frames 203 to form a substantially rectangular forward frame assembly 20.

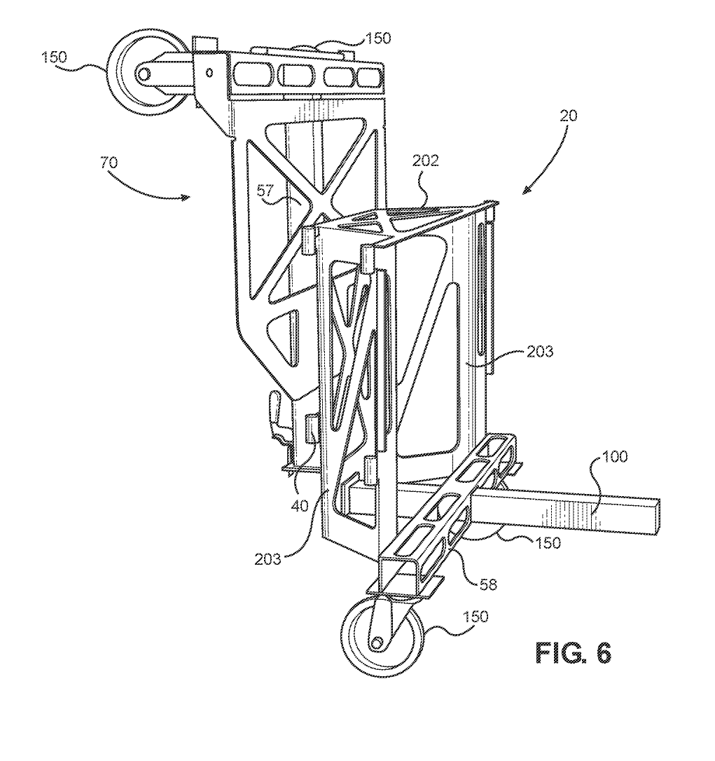

Extending outward from the forward frame assembly 20 in FIG. 4 are door pin sleeves 40. At least one door pin sleeve 40 is disposed outboard of each of the first and second upright frames 203, whereby each door pin sleeve is adapted to support a door pin of a supported vehicle door therethrough. The frames 203, 201, 202 may either comprise solid, planar frames or open structures as shown. In particular, the first and second upright frames 203 may comprise an open structure with cross beams 211 therealong. Similarly, the third 201 and fourth 202 frames may comprise solid, planar structures as depicted in FIG. 4, or open structures. Furthermore, the third 201 and fourth 202 frames may extend upwardly and laterally between the first and second upright frames 203, or the third 201 and fourth 202 frames may extend horizontally and laterally thereacross (see item 202 in FIG. 6).

Similar to the forward frame assembly 20, the rear frame 70 may comprise a solid surface or an open frame structure. The rear frame 70 is disposed along the rear of the lower frame and extends upward from the rear member 59 of the lower frame. The rear frame 70 may have a plurality of door strike pins 71 therealong, and may comprise a static structure or one that is rotatable using one or more hinges 78. The door strike pins 71 are adapted to secure to a door latch of a vehicle door, whereby each of the door strike pins 71 is longitudinally aligned with at least one of the door pin sleeves 40 of the forward frame assembly to form a set of door supports. Each set of door supports is adapted to support a single vehicle door.

In the embodiment shown in FIG. 4, the forward frame assembly 20 may comprise two different sets of door pin sleeves: those for front (longer) doors, and those for rear (shorter) doors. In particular, a forward pair of door pin sleeves may be provided and a rear pair of door pin sleeves may be provided along both sides of the forward frame assembly 20. Each of the pairs of door pin sleeves 40 extend outward forward frame assembly 20, but to a different extent. The forward pair of door pin sleeves is vertically aligned and the rear pair of door pin sleeves is vertically aligned. Similarly, the forward pair of door pin sleeves is disposed closer to the front of the lower frame than the rear pair of door pin sleeves. However, the forward pair of door pin sleeves on both sides of the forward frame assembly are disposed outboard of the rear pair of door pin sleeves.

Similarly, the plurality of door strike pins 71 on the rear frame 70 comprises a pair of outer door strike pins and a pair of inner door strike pins. The outer door strike pins align longitudinally with one of the forward pair of door pin sleeves of forward frame assembly. The inner door strike pins align longitudinally with one of the rear pair of door pin sleeves of the forward frame assembly. In this way, smaller vehicle doors are supported between the inner door strike pins and the rear door pin sleeves, as compared to vehicle doors supported between the outer door strike pins and the forward door pin sleeves.

Also contemplated and as illustrated in FIG. 4 are one or more caster wheels 150 that are attachable along the lower surface of the carrier. Caster wheels 150 may be affixed to the lower frame 50 such that the carrier may be transported by rolling the carrier (with or without vehicle doors affixed thereto) from one location to another when not supported by a lead vehicle. This allows the user to move the carrier easily, and even move the carrier when doors may be mounted thereto.

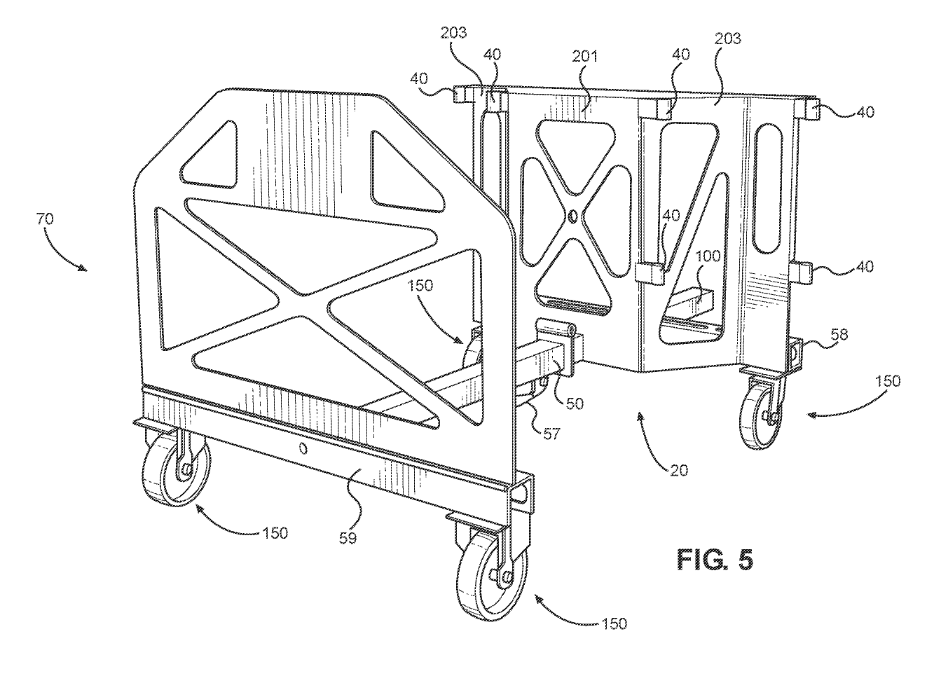

Referring now to FIGS. 5 and 6, an additional embodiment of the present invention is presented. In this embodiment, the lower frame 50 comprises a longitudinal member 57 and a pair of cross members 59, 58. The lower frame 50 supports the forward frame assembly 20 and the rear frame 70. The forward frame assembly 20 comprises a first and second upright frame member 203 and a third 201 and fourth 202 frame member extending laterally therebetween. The third 201 and fourth 202 frame members may extend in an upright condition or in a horizontal condition between the first and second upright frame members 203. The forward frame assembly also provides door pin sleeves 40 therealong.

In this embodiment, however, it is contemplated that the rear frame member 70 and the rear cross member 59 are stowable in an upright condition against the forward frame assembly 20. To achieve this, a lockable hinge 150 is disposed along the longitudinal member 57 that allows the rear frame 70 and rear cross member 59 to pivot upwards from the forward frame assembly 20 when the rear frame 70 is folded downward against the longitudinal member 57 (see FIG. 6). This allows the carrier to achieve a stowed condition, whereby the overall length of the carrier is reduced. The draw bar 100 of the carrier may be supported by a vehicle in this condition, or alternatively the device may be supported in this condition by the caster wheels 150 along the forward frame assembly 20 when the carrier is not in use. The lockable hinge 150 that allows the longitudinal member 57 to pivot along its length and lock into a deployed state. This ensures the longitudinal member 57 remains extended when the device is supporting doors thereon. The lockable hinge 150 may also have a second lockable position when the longitudinal member is pivoted upwards and in the stowed state.

Overall, the present invention is a vehicle door carrier. The device is a trailer hitch carrier used to support a set of vehicle doors from a sport utility or off road vehicle. In particular, removable Jeep® vehicle doors may be supported on the carrier. The vehicle doors are operably removable from the vehicle, and the carrier of the present invention provides a means to support the doors from the same (or another) vehicle when removed.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A hitch-mounted door carrier for supporting vehicle doors, comprising:
a substantially rectangular lower frame having a pair of side frame members and a pair of cross frame members;
the lower frame having a front and a rear;
a draw bar extending from the front of the lower frame;
a first upright member and a second upright member extending upward from the lower frame;
a third upright member and a fourth upright member extending upward from the lower frame;
whereby the third upright member and the fourth upright member are both positioned laterally inboard of the first upright member and the second upright member;
at least one door pin sleeve disposed on each of the first upright member, the second upright member, the third upright member, and the fourth upright member;
each door pin sleeve adapted to support a door pin of a vehicle door therethrough;
a rear frame disposed along the rear of the lower frame.

2) The hitch-mounted door carrier of claim 1, wherein:
the rear frame extending upward from the lower frame and having a plurality of door strike pins therealong;
the door strike pins being adapted to secure to a door latch of a vehicle door;
whereby each of the door strike pins is longitudinally aligned with at least one of the door pin sleeves to form a set of door supports, whereby each set of door supports is adapted to support a single vehicle door.

3) The hitch-mounted door carrier of claim 2, wherein:
the plurality of door strike pins on the rear frame comprises a pair of outer door strike pins and a pair of inner door strike pins;
the outer door strike pins aligning longitudinally with the door pin sleeves of the first upright member and the second upright member;
the inner door strike pins aligning longitudinally with the door pin sleeves of the third upright member and the fourth upright member;
whereby smaller vehicle doors are supported between the inner door strike pins and the third upright member and the fourth upright member, as compared to vehicle doors supported between the outer door strike pins and the first upright member and the second upright member.

4) The hitch-mounted door carrier of claim 1, wherein:
the third upright member and the fourth upright member are rearward of the first upright member and the second upright member, such that the third upright member and the fourth upright member are closer to the rear frame than the first upright member and the second upright member.

5) The hitch-mounted door carrier of claim 1, wherein:
the rear frame is hingedly attached along the rear of the lower frame;
whereby the rear frame is rotatable between an upright position and a lowered position.

6) The hitch-mounted door carrier of claim 5, wherein:
the rear frame further between the lower frame and rear frame further comprises a longitudinal member extending along the longitudinal centerline of the lower frame and extending from the lower frame to the rear frame;
a lockable hinge along the longitudinal member between the lower frame and the rear frame;
wherein the longitudinal member is adapted to operably pivot upwards about the lockable hinge between the lower frame and the rear frame when stowing the rear frame.

7) The hitch-mounted door carrier of claim 1, wherein:
the rear of the lower frame further comprises vehicle taillights;
the vehicle taillights further comprising an electrical connector to receive electrical signals from a lead vehicle when the drawbar is attached to a vehicle trailer hitch.

8) The hitch-mounted door carrier of claim 1, wherein:
the first upright member is connected to the third upright member by at least one diagonal brace;
wherein the second upright member is connected to the fourth upright member by at least one diagonal brace;
each of the diagonal braces is parallel to the lower frame.

9) The hitch-mounted door carrier of claim 1, wherein:
rear vehicle doors are supported between the rear frame and the third upright member and the fourth upright member; and
front vehicle doors are supported between the rear frame and the first upright member and the second upright member.

10) The hitch-mounted door carrier of claim 1, wherein:
the first upright member and second upright member each further comprise a pair of vertically aligned door pin sleeves; and
wherein the third upright member and fourth upright member each further comprise a pair of vertically aligned door pin sleeves.

11) A hitch-mounted door carrier for supporting vehicle doors, comprising:
a substantially rectangular lower frame having a pair of side frame members and a pair of cross frame members;
the lower frame having a front and a rear;
a draw bar extending from the front of the lower frame;
a first upright member and a second upright member extending upward from the lower frame;
at least one door pin sleeve disposed on each of the first upright member and the second upright member;
each door pin sleeve adapted to support a door pin of a vehicle door therethrough;
a rear frame disposed along the rear of the lower frame.

12) The hitch-mounted door carrier of claim 11, wherein:
the rear frame extending upward from the lower frame and having a plurality of door strike pins therealong;
the door strike pins being adapted to secure to a door latch of a vehicle door;
whereby each of the door strike pins is longitudinally aligned with at least one of the door pin sleeves to form a set of door supports, whereby each set of door supports is adapted to support a single vehicle door.

13) The hitch-mounted door carrier of claim 11, wherein:
the rear frame is hingedly attached along the rear of the lower frame;
whereby the rear frame is rotatable between an upright position and a lowered position.

14) The hitch-mounted door carrier of claim 13, further comprising:
a lockable hinge along the lower frame;
wherein the lower frame is adapted to operably pivot upwards about the lockable hinge when stowing the rear frame.

15) The hitch-mounted door carrier of claim 11, wherein:
the rear of the lower frame further comprises vehicle taillights;
the vehicle taillights further comprising an electrical connector to receive electrical signals from a lead vehicle when the drawbar is attached to a vehicle trailer hitch.

16) A hitch-mounted door carrier for supporting vehicle doors, comprising:
a lower frame having a longitudinal member and a rear member substantially perpendicular thereto;
the lower frame having a front and a rear;
a draw bar extending from the front of the lower frame;
the rear member disposed along the rear of the lower frame;
a first upright frame and a second upright frame extending upward from the lower frame and extending longitudinally along the lower frame;
a third upright frame and a fourth upright frame extending laterally between the first upright frame and the second upright frame;
at least one door pin sleeve disposed outboard of the first upright frame and the second upright frame;
each door pin sleeve adapted to support a door pin of a vehicle door therethrough;
a rear frame disposed along the rear of the lower frame.

17) The hitch-mounted door carrier of claim 16, further comprising:
the rear frame extending upward from the rear member of the lower frame and having a plurality of door strike pins therealong;
the door strike pins being adapted to secure to a door latch of a vehicle door;
whereby each of the door strike pins is longitudinally aligned with at least one of the door pin sleeves to form a set of door supports, whereby each set of door supports is adapted to support a single vehicle door.

18) The hitch-mounted door carrier of claim 16, further comprising:
a forward pair of door pin sleeves and a rear pair of door pin sleeves extending outward from the first upright frame; and
a forward pair of door pin sleeves and a rear pair of door pin sleeves extending outward from the second upright frame;
whereby the forward pair of door pin sleeves are vertically aligned and the rear pair of door pin sleeves are vertically aligned;
whereby the forward pair of door pin sleeves is disposed closer to the front of the lower frame than the rear pair of door pin sleeves.

19) The hitch-mounted door carrier of claim 18, further comprising:
whereby the forward pair of door pin sleeves are disposed outboard of the rear pair of door pin sleeves.

20) The hitch-mounted door carrier of claim 18, wherein:
the plurality of door strike pins on the rear frame comprises a pair of outer door strike pins and a pair of inner door strike pins;
the outer door strike pins aligning longitudinally with one of the forward pair of door pin sleeves of the first upright frame and the second upright frame;
the inner door strike pins aligning longitudinally with one of the rear pair of door pin sleeves of the first upright frame and the second upright frame;
whereby smaller vehicle doors are supported between the inner door strike pins and the rear door pin sleeves, as compared to vehicle doors supported between the outer door strike pins and the forward door pin sleeves.

21) The hitch-mounted door carrier of claim 16, wherein:
the rear frame is hingedly attached along the rear of the longitudinal member;
whereby the rear frame is rotatable between an upright position and a lowered position.

22) The hitch-mounted door carrier of claim 21, further comprising:
a lockable hinge along the longitudinal member between the lower frame and the rear frame;
wherein the longitudinal member is adapted to operably pivot upwards about the lockable hinge between the lower frame and the rear frame when stowing the rear frame.

23) The hitch-mounted door carrier of claim 16, wherein:
the rear of the lower frame further comprises vehicle taillights;
the vehicle taillights further comprising an electrical connector to receive electrical signals from a lead vehicle when the drawbar is attached to a vehicle trailer hitch.
